(19) United States
(12) Patent Application Publication
(10) Pub. No.: US 2024/0254414 A1
(43) Pub. Date: Aug. 1, 2024

(54) PARTICLES INCLUDING ENZYME

(71) Applicant: The Procter & Gamble Company, Cincinnati, OH (US)

(72) Inventors: Montserrat Guadalupe VASQUEZ VALDIVIESO, Newcastle upon Tyne (GB); Neil Joseph LANT, Newcastle upon Tyne (GB)

(21) Appl. No.: 18/582,818

(22) Filed: Feb. 21, 2024

Related U.S. Application Data
(63) Continuation of application No. 15/064,171, filed on Mar. 8, 2016.

(51) Int. Cl. C11D 3/386; C11D 3/37; C11D 3/50; C11D 17/06

(52) U.S. Cl. CPC C11D 3/38636; C11D 3/3707; C11D 3/386; C11D 3/38672; C11D 3/505; C11D 17/06

(57) ABSTRACT

A composition including a plurality of particles. The particles include from about 40% to about 99% by weight of said particles of a carrier and from about 0.0001% to about 5% by weight of an enzyme. Each of the particles has a mass between about 1 mg to about 5000 mg.

### FIELD OF THE INVENTION

Particulate laundry additive.

### REFERENCE TO AN ELECTRONIC SEQUENCE LISTING

The contents of the electronic sequence listing (14233C_ST.26.XML; Size: 7,241 bytes; and Date of Creation: Feb. 21, 2024) is herein incorporated by reference in its entirety.

### BACKGROUND OF THE INVENTION

Consumers of laundry detergents enjoy having the ability to customize the technologies they use in caring for their clothes and household fabrics. This is evidenced by the vast number of choices of cycles and variations to choose from on modern washing machines, the variety of pretreatment and wash additives, and the variety of laundry treatment compositions to choose from in the market place. Further, consumers also enjoy having the ability to customize the quantity of laundry treatment composition delivered to the wash.

Enzymes are a laundry treatment agent that can provide fantastic benefits to the consumer. Enzymes are widely known for raising the performance of primary and secondary detergency in laundry products. Enzymes can provide for stain removal, whiteness, color care, and fabric care. Typically, enzymes are provided as but a single component of a liquid or powder detergent composition. The level of enzyme can only be customized by the consumer by using more or less of the laundry treatment composition. So, to achieve customization of the enzyme level, the consumer also has to accept a corresponding increase or decrease in other benefit agents such as perfume, bleach, brightener, surfactant, softening agent, feel agent, and other benefit agents commonly provided in fully formulated laundry detergent products. The level of these other benefit agents may be increased or decreased to a degree that they are not pleasurable to experience or do not function.

Care enzymes can be particularly practical for restoring color to fabrics by removing fuzz and pills from the fabric. One particular care enzyme that can provide a fabric care benefit is glycosyl hydrolase family 45. This enzyme can provide a fabric care benefit by removing microfibrils from cellulosic fabrics such as cotton, linen, ramie, viscose, and lyocell. Microfibrils in textiles can look hairy and scatter incident light which can reduce the brightness of colors. Other care enzymes include cutinase and P-nitrobenzylesterase.

Providing glycosyl hydrolase family 45 in a fully formulated powder detergent composition can be convenient and the level of this enzyme is typically low in such a composition. However, if such compositions contain protease enzyme, the glycosyl hydrolase family 45 can be deleteriously degraded in the presence of the protease enzyme. Protease enzymes are a common component of laundry detergent compositions because they can be effective at treating stains comprising proteins. Since protease enzymes are a preferential component of laundry detergent formulations, incorporating care enzymes, including glycosyl hydrolase family 45 enzyme, poses a common challenge to product designers.

Nucleases are another enzyme that can be desirable to provide in a form that consumers can easily employ. Nucleases can help decrease malodor associated with laundered articles.

Providing an enzyme as a stand-alone particulate product can be challenging because the particle sizes in which such enzyme is available are too small to be conveniently handled and small particles can undesirably become airborne. Providing enzyme in a concentrated solution can also be undesirable because of problems associated with accurately dosing such a product. As such, providing care enzymes in a formula or in a product that can be conveniently used by consumers to restore color to fabrics is a challenge.

With these limitations in mind, there is a continuing unaddressed need for a particulate composition containing care enzyme that provides consumers with the ability to conveniently control the amount of care enzyme delivered to the wash.

### SUMMARY OF THE INVENTION

A composition comprising a plurality of particles, wherein said particles comprise: from about 40% to about 99% by weight of said particles of a carrier; and from about 0.0001% to about 5% by weight of an enzyme selected from the group consisting of care enzyme, nuclease, and combinations thereof; and wherein each of said particles has a mass between about 1 mg to about 5000 mg.

A process for treating laundry articles comprising the steps of: providing particles comprising: from about 40% to about 99% by weight of said particles of a carrier; and from about 0.0001% to about 5% by weight of an enzyme selected from the group consisting of care enzyme, nuclease, and combinations thereof; placing a dose of said particles in a dosing cup; and dispensing said dose of said particles into a washing machine; wherein each of said particles has a mass between about 1 mg to about 5000 mg.

A process for forming particles comprising the steps of: providing a precursor material; providing a distributor having a plurality of apertures; passing said precursor material through said apertures; providing a moving conveyor beneath said distributor; depositing said precursor material onto said moving conveyor; and cooling said precursor material to form a plurality of particles; wherein said precursor material comprises polyethylene glycol, wherein said polyethylene glycol has a weight average molecular weight from about 2000 to about 13000; wherein said precursor material comprises from about 0.0001% to about 5% by weight of said precursor material of an enzyme selected from the group consisting of care enzyme, nuclease, and combinations thereof; and wherein said precursor material is provided at a temperature less than about 70° C.

### BRIEF DESCRIPTION OF THE DRAWINGS

FIG. 1 is a apparatus for forming particles.

### DETAILED DESCRIPTION OF THE INVENTION

Care enzymes can restore color to fabrics by removing fuzz and pills from the fabric. Fuzz and pills tends to disperse light which results in the fabric appearing to have a dull color.

Care enzymes are available in liquid or solid form. Liquid forms of care enzymes can be conveniently formulated into liquid detergent compositions. Typically, liquid detergent compositions comprise multiple enzymes to help aid with removal of stains. Different staining materials are susceptible to being broken down by different enzymes. Protease enzymes are widely used in liquid detergent compositions to break down protein-containing stains such as grass, blood, mucus, and the like. Unfortunately, care enzymes tend to be degraded in the presence of protease enzyme. As such, formulating liquid detergent compositions that include both care enzymes and protease can be difficult.

Solid forms of care enzymes also suffer from incompatibility with protease enzymes, which may limit their use in powder detergent compositions that also contain protease enzyme. Solid forms of care enzymes can also undesirably become airborne.

Care enzymes can be provided in particulate form as described herein. The particles can comprise about 40% to about 99% by weight of the particles a carrier and about 0.0001% to about 5% by weight of said particles of a care enzyme. The particles can comprise about 45% to about 99% by weight of the particles a carrier and about 0.5% to about 5% by weight of said particles of a care enzyme. The particles can comprise about 0.001% to about 5% by weight of said particles of a care enzyme.

Optionally, for any of the compositions disclosed herein, individual particles can have a mass of from about 1 mg to about 5000 mg, alternatively from about 5 mg to about 1000 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg, alternatively combinations thereof and any whole numbers or ranges of whole numbers of mg within any of the aforementioned ranges. Particles having a mass in the aforesaid ranges can have dissolution times in water that permit the particles to dissolve during a typical wash cycle. In a plurality of particles, individual particles can have a shape selected from the group consisting of spherical, hemispherical, compressed hemispherical, lentil shaped, and oblong.

The plurality of particles can have a mean particle mass of from about 1 mg to about 5000 mg, alternatively from about 5 mg to about 1000 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg. The plurality of particles can have standard deviation of mass of less than about 30 mg, alternatively less than about 15 mg, alternatively less than about 5 mg, alternatively about 3 mg. The mean particle of mass within the aforesaid ranges can provide for a dissolution time in water that permits the particles to dissolve during a typical wash cycle. Without being bound by theory, it is thought that particles have such a standard deviation of mass can have a more uniform dissolution time in water as compared to particles having a broader standard deviation of mass. The smaller the standard deviation of mass of the particles the more uniform the dissolution time. The mass of the individual particles forming the plurality particles can be set to provide the desired dissolution time, which might be some fraction of the length of the typical washing cycle in a washing machine. Particles formed from polyethylene glycol having a weight average molecular weight of about 9000 can have mean particle mass of about 38 mg and standard deviation of mass of about 3 mg.

An individual particle may have a volume from about 0.003 cm³ to about 5 cm³. An individual particle may have a volume from about 0.003 cm³ to about 1 cm³. An individual particle may have a volume from about 0.003 cm³ to about 0.5 cm³. An individual particle may have a volume from about 0.003 cm³ to about 0.2 cm³. An individual particle may have a volume from about 0.003 cm³ to about 0.15 cm³. Smaller particles are thought to provide for better packing of the particles in a container and faster dissolution in the wash.

The composition can comprise particles that are retained on a number 10 sieve as specified by ASTM International, ASTM E11-13. The composition can comprise particles wherein more than about 50% by weight of the particles are retained on a number 10 sieve as specified by ASTM International, ASTM E11-13. The composition can comprise particles wherein more than about 70% by weight of the particles are retained on a number 10 sieve as specified by ASTM International, ASTM E11-13. The composition can comprise particles wherein more than about 90% by weight of the particles are retained on a number 10 sieve as specified by ASTM International, ASTM E11-13. It can be desirable to provide particles sized as such because particles retained on a number 10 sieve may be easier to handle than smaller particles.

The composition can comprise particles that are retained on a number 6 sieve as specified by ASTM International, ASTM E11-13. The composition can comprise particles wherein more than about 50% by weight of the particles are retained on a number 6 sieve as specified by ASTM International, ASTM E11-13. The composition can comprise particles wherein more than about 70% by weight of the particles are retained on a number 6 sieve as specified by ASTM International, ASTM E11-13. The composition can comprise particles wherein more than about 90% by weight of the particles are retained on a number 6 sieve as specified by ASTM International, ASTM E11-13. It can be desirable to provide particles sized as such because particles retained on a number 6 sieve may be easier to handle than smaller particles.

The composition can comprise particles that pass a sieve having a nominal sieve opening size of 22.6 mm. The composition can comprise particles that pass a sieve having a nominal sieve opening size of 22.6 mm and are retained on a sieve having a nominal sieve opening size of 0.841 mm. Particles having a size such that they are retained on a sieve having a nominal opening size of 22.6 mm may tend to have a dissolution time that is too great for a common wash cycle. Particles having a size such that they pass a sieve having a nominal sieve opening size of 0.841 mm may be too small to conveniently handle. Particles having a size within the aforesaid bounds may represent an appropriate balance between dissolution time and case of particle handling.

Particles having the size disclosed herein can be substantial enough so that they do not readily become airborne when poured from a container, dosing cup, or other apparatus, into a wash basin or washing machine. Further, such particles as disclosed herein can be easily and accurately poured from a container into a dosing cup. So such particles make it easy for the consumer to control the amount of enzyme she delivers to the wash.

A plurality of particles may collectively comprise a dose for dosing to a laundry washing machine or laundry wash basin. A single dose of the particles may comprise from about 1 g to about 27 g of particles. A single dose of the particles may comprise from about 5 g to about 27 g, alternatively from about 13 g to about 27 g, alternatively from about 14 g to about 20 g, alternatively from about 15 g to about 19 g, alternatively from about 18 g to about 19 g, alternatively combinations thereof and any whole numbers of grams or ranges of whole numbers of grams within any of the aforementioned ranges. The individual particles forming the plurality of particles that can make up the dose can have a mass from about 1 mg to about 5000 mg, alternatively from about 5 mg to about 1000 mg, alternatively from about 5 mg to about 200 mg, alternatively from about 10 mg to about 100 mg, alternatively from about 20 mg to about 50 mg, alternatively from about 35 mg to about 45 mg, alternatively about 38 mg, alternatively combinations thereof and any whole numbers or ranges of whole numbers of mg within any of the aforementioned ranges. The plurality of particles can be made up of particles having different size, shape, and/or mass. The particles in a dose can each have a maximum dimension less than about 15 mm. Each of the particles in a dose can have a maximum dimension less than about 1 cm.

The particles disclosed herein can be conveniently employed to treat laundry articles. The steps of the process can be to provide such particles comprising the formulation components disclosed herein. A dose of the particles can be placed in a dosing cup. The dosing cup can be the closure of a container containing the particles. The dosing cup can be a detachable and attachable dosing cup that is detachable and attachable to a container containing the particles or to the closure of such container. The dose of particles in the dosing cup can be dispensed into a washing machine. The step of dispensing the particles in the washing machine can take place by pouring the particles into the washing machine or placing the dosing cup and the particles contained therein into the washing machine.

### Carrier

The carrier can be or comprise a material selected from the group consisting of water soluble inorganic alkali metal salt, water-soluble alkaline earth metal salt, water-soluble organic alkali metal salt, water-soluble organic alkaline earth metal salt, water soluble carbohydrate, water-soluble silicate, water soluble urea, and any combination thereof. Alkali metal salts can be, for example, selected from the group consisting of salts of lithium, salts of sodium, and salts of potassium, and any combination thereof. Useful alkali metal salts can be, for example, selected from the group consisting of alkali metal fluorides, alkali metal chlorides, alkali metal bromides, alkali metal iodides, alkali metal sulfates, alkali metal bisulfates, alkali metal phosphates, alkali metal monohydrogen phosphates, alkali metal dihydrogen phosphates, alkali metal carbonates, alkali metal monohydrogen carbonates, alkali metal acetates, alkali metal citrates, alkali metal lactates, alkali metal pyruvates, alkali metal silicates, alkali metal ascorbates, and combinations thereof.

Alkali metal salts can be selected from the group consisting of, sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium acetate, sodium citrate, sodium lactate, sodium tartrate, sodium silicate, sodium ascorbate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium acetate, potassium citrate, potassium lactate, potassium tartrate, potassium silicate, potassium, ascorbate, and combinations thereof. Alkaline earth metal salts can be selected from the group consisting of salts of magnesium, salts of calcium, and the like, and combinations thereof. Alkaline earth metal salts can be selected from the group consisting of alkaline metal fluorides, alkaline metal chlorides, alkaline metal bromides, alkaline metal iodides, alkaline metal sulfates, alkaline metal bisulfates, alkaline metal phosphates, alkaline metal monohydrogen phosphates, alkaline metal dihydrogen phosphates, alkaline metal carbonates, alkaline metal monohydrogen carbonates, alkaline metal acetates, alkaline metal citrates, alkaline metal lactates, alkaline metal pyruvates, alkaline metal silicates, alkaline metal ascorbates, and combinations thereof. Alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium acetate, magnesium citrate, magnesium lactate, magnesium tartrate, magnesium silicate, magnesium ascorbate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, and combinations thereof. Inorganic salts, such as inorganic alkali metal salts and inorganic alkaline earth metal salts, do not contain carbon. Organic salts, such as organic alkali metal salts and organic alkaline earth metal salts, contain carbon. The organic salt can be an alkali metal salt or an alkaline earth metal salt of sorbic acid (i.e., absorbate). Sorbates can be selected from the group consisting of sodium sorbate, potassium sorbate, magnesium sorbate, calcium sorbate, and combinations thereof.

The carrier can be or comprise a material selected from the group consisting of a water-soluble inorganic alkali metal salt, a water-soluble organic alkali metal salt, a water-soluble inorganic alkaline earth metal salt, a water-soluble organic alkaline earth metal salt, a water-soluble carbohydrate, a water-soluble silicate, a water-soluble urea, and combinations thereof. The carrier or water soluble-soluble carrier can be selected from the group consisting of sodium chloride, potassium chloride, calcium chloride, magnesium chloride, sodium sulfate, potassium sulfate, magnesium sulfate, sodium carbonate, potassium carbonate, sodium hydrogen carbonate, potassium hydrogen carbonate, sodium acetate, potassium acetate, sodium citrate, potassium citrate, sodium tartrate, potassium tartrate, potassium sodium tartrate, calcium lactate, water glass, sodium silicate, potassium silicate, dextrose, fructose, galactose, isoglucose, glucose, sucrose, raffinose, isomalt, xylitol, candy sugar, coarse sugar, and combinations thereof. In one embodiment, the carrier or water-soluble carrier can be sodium chloride. In one embodiment, the carrier or water-soluble carrier can be table salt.

The carrier can be or comprise a material selected from the group consisting of sodium bicarbonate, sodium sulfate, sodium carbonate, sodium formate, calcium formate, sodium chloride, sucrose, maltodextrin, corn syrup solids, corn starch, wheat starch, rice starch, potato starch, tapioca starch, clay, silicate, citric acid carboxymethyl cellulose, fatty acid, fatty alcohol, glyceryl diester of hydrogenated tallow, glycerol, and combinations thereof.

The carrier can be selected from the group consisting of water soluble organic alkali metal salt, water soluble inorganic alkaline earth metal salt, water soluble organic alkaline earth metal salt, water soluble carbohydrate, water soluble silicate, water soluble urea, starch, clay, water insoluble silicate, citric acid carboxymethyl cellulose, fatty acid, fatty alcohol, glyceryl diester of hydrogenated tallow, glycerol, polyethylene glycol, and combinations thereof.

The carrier can be selected from the group consisting of disaccharides, polysaccharides, silicates, zeolites, carbonates, sulfates, citrates, and combinations thereof.

Examples of water soluble polymers include but are not limited to polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; cellulose, alkyl cellulosics such as methyl cellulose, ethyl cellulose and propyl cellulose; cellulose ethers; cellulose esters; cellulose amides; polyvinyl acetates; polycarboxylic acids and salts; polyaminoacids or peptides; polyamides; polyacrylamide; copolymers of maleic/acrylic acids; polysaccharides including starch, modified starch; gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth; and combinations thereof. In one embodiment the polymer comprises polyacrylates, especially sulfonated polyacrylates and water-soluble acrylate copolymers; and alkylhydroxy cellulosics such as methylcellulose, carboxymethylcellulose sodium, modified carboxy-methylcellulose, dextrin, ethylcellulose, propylcellulose, hydroxyethyl cellulose, hydroxypropyl methylcellulose, maltodextrin, polymethacrylates. In yet another embodiment the polymer comprises PVA; PVA copolymers; hydroxypropyl methyl cellulose (HPMC); and mixtures thereof.

The particles can comprise from about 40% by weight to about 99% by weight of the particles of the carrier. The particles can comprise from about 45% by weight to about 99% by weight of the particles of the carrier. The particles can comprise from about 45% by weight to about 92% by weight of the particles of the carrier. The particles can comprise from about 40% by weight to about 99% by weight of the particles of the carrier.

The carrier can be polyethylene glycol (PEG). PEG can be a convenient material to employ to make particles because it can be sufficiently water soluble to dissolve during a wash cycle when the particles are within the aforesaid range of mass. Further, PEG can be easily processed as melt. The melt temperature of PEG can vary as a function of molecular weight of the PEG. The melt temperature of PEG, depending on molecular weight and or distribution of molecular weight, can be low enough such that when the particles comprising PEG and care enzyme are formed from a melt that includes PEG and the care enzyme, the activity of the care enzyme remains high enough to be able to restore the color of textiles.

The particles can comprise more than about 40% by weight PEG having a weight average molecular weight from about 2000 to about 13000. PEG has a relatively low cost, may be formed into many different shapes and sizes, minimizes unencapsulated perfume diffusion, and dissolves well in water. PEG comes in various weight average molecular weights. A suitable weight average molecular weight range of PEG includes from about 2,000 to about 13,000, from about 4,000 to about 12,000, alternatively from about 5,000 to about 11,000, alternatively from about 6,000 to about 10,000, alternatively from about 7,000 to about 9,000, alternatively combinations thereof. PEG is available from BASF, for example PLURIOL E 8000.

The particles can comprise more than about 40% by weight of the particles of PEG. The particles can comprise more than about 50% by weight of the particles of PEG. The particles can comprise more than about 60% by weight of the particles of PEG. The particles may comprise from about 65% to about 99% by weight of the composition of PEG. The particles may comprise from about 40% to about 99% by weight of the composition of PEG. The particles may comprise from about 45% to about 99% by weight of the composition of PEG.

Alternatively, the particles can comprise from about 40% to less than about 90%, alternatively from about 45% to about 75%, alternatively from about 50% to about 70%, alternatively combinations thereof and any whole percentages or ranges of whole percentages within any of the aforementioned ranges, of PEG by weight of the particles.

The plurality of particles can be substantially free from particles having a mass less than about 10 mg. This can be practical for limiting the ability of the particles to become airborne.

Depending on the application, the particles can comprise from about 0.5% to about 5% by weight of the particles of a balancing agent selected from the group consisting of glycerin, polypropylene glycol, isopropyl myristate, dipropylene glycol, 1,2-propanediol, and PEG having a weight average molecular weight less than 2,000, and mixtures thereof. The balancing agent can be practical for providing particles having the same processing characteristics even though the particles have different formulations. For instance, two different scent variants of a product may have different levels of perfume. With use of a balancing agent, the PEG level can be the same in each scent variant and the formulas can be balanced with the balancing agent. This can make processing simpler in that the formulas for the scent variants will have the same level of PEG and may have similar processing characteristics.

The particles can comprise an antioxidant. The antioxidant can help to promote stability of the color and or odor of the particles over time between production and use. The particles can comprise between about 0.01% to about 1% by weight antioxidant. The particles can comprise between about 0.001% to about 2% by weight antioxidant. The particles can comprise between about 0.01% to about 0.1% by weight antioxidant. The antioxidant can be butylated hydroxytoluene.

### Enzyme

The enzyme in the particles can be provided at a level of 0.0001% to about 5% by weight of the particles an enzyme selected from the group consisting of care enzyme, nuclease, and combinations thereof. The enzyme in the particles can be provided at a level of 0.001% to about 5% by weight of the particles an enzyme selected from the group consisting of care enzyme, nuclease, and combinations thereof. The enzyme in the particles disclosed herein can be an enzyme selected from the group consisting amylase, lipase, protease, cellulase, xyloglucanase, pectate lyase, peroxidases, mannanase, cutinases, P-nitrobenzylesterases, nucleases, and mixtures thereof. The enzyme in the particles can be provided at a level of 0.0001% to about 5% by weight of the particles. The enzyme in the particles can be provided at a level of 0.001% to about 5% by weight of the particles. These enzymes when used in laundering processes, can provide for one or more of stain removal, fabric rejuvenation, and malodor remediation. The enzyme can be nuclease, which can reduce malodor associated with fabrics.

With respect to nucleases, providing such enzyme in a particle as disclosed herein can be practical in that time is required for the particle to dissolve in the wash and release appreciable amounts of enzyme into the wash solution. This delay in release time allows for the surfactant and other components in the wash solution to start removing soils, thereby leaving the nucleic acids unprotected. Once released in sufficient quantity, the nucleases can target such nucleic acids and break down stains comprising such nucleic acids.

The enzyme can be in liquid, solid, or other form. The enzyme can be substantially homogeneously mixed with the carrier. Substantially homogeneously mixed components need not be perfectly homogeneous. The degree of homogeneity can be that which can be provided by mixing processes used by those skilled in the art in commercial applications to make particles.

Contemplated herein are enzyme particulates carried by the carrier of the particles. Enzyme particulates have an enzyme carrier and enzyme dispersed in the enzyme carrier. The enzyme particulate can be substantially homogeneously mixed with the carrier. So, an enzyme particulate dispersed substantially uniformly within the carrier can be considered to be substantially homogeneously mixed. Specifically contemplated herein are particles that comprise a carrier and an enzyme particulate substantially homogeneously mixes with the carrier with the enzyme particulate comprising enzyme and an enzyme carrier.

The enzyme can be in liquid form in the form of droplets substantially homogeneously mixed the carrier. The liquid enzyme can be distributed or dispersed in the carrier.

Enzyme carriers can be selected from the group consisting of sodium sulphate, sucrose, starch, polyvinyl alcohol, cellulose, dextrin, polybranched polyamine, and mixtures thereof. Useful enzyme carriers can comprise sodium sulphate, sucrose, starch, and polyvinyl alcohol. Enzyme carrier can comprise cellulose, for example fibrous cellulose, dextrin, and sodium sulphate. Enzyme carrier can comprise polybranched polyamine.

Care enzymes can be practical to include in particles disclosed herein. Care enzymes are enzymes active at restoring color to fabrics by removing fuzz and pills from the surface of a textile. The care enzyme can be a cellulase. The care enzyme can be an enzyme of the glycoside hydrolase family. Glycoside Hydrolase Family means any Glycoside Hydrolase Family (designated by number) of the Glycoside Hydrolase Family Classification system, based on amino acid similarities, being part of the Carbohydrate-Active Enzymes database (CAZy) developed by the Glycogenomics group at Architecture et Fonction des Macromolecules Biologiques, Unite Mixte de Recherches UMR6098, CNRS, Universite de Provence Universite de la Mediterranee.

The care enzyme can be an enzyme of the glycosyl hydrolase family 45. Glycoside Hydrolase Family 45 includes the inverting enzymes of endoglucanase (EC 3.2.1.4).

The care enzyme can be cellulase that is alkaline or neutral cellulase having a color care benefits. The care enzymes, as disclosed herein, can have a molecular weight of from about 17 kDa to about 30 kDa. The care enzyme can be, for example, the endoglucanases sold under the tradename Biotouch® NCD, DCC and DCL (AB Enzymes, Darmstadt, Germany). Other preferred commercially available cellulases include CELLUZYME, CAREZYME, and RENOZYME (Novozymes A S), CLAZINASE, PURADAX HA, PURADAX® EG-L, and PURADAx® HA (Genencor International Inc.), and KAC-500(B), KAC®-500(B) (Kao Corporation).

Other care enzymes that can provide for an anti-pilling appearance benefit include cutinase (cutin hydrolases—EC 3.1.1.74) and P-nitrobenzylesterases (carboxyl esterases—EC 3.1.1.1). Examples of cutinase can be found in EP2767582A1. Examples of P-nitrobenzylesterases can be found in WO2007017181 and WO2015135757.

The care enzyme, if provided, can be selected from the group consisting of glycoside hydrolase family 45, cutinase, and P-nitrobenzylesterase, and mixtures thereof.

The particles can comprise about 40% to about 99% by weight of the particles a carrier and about 0.0001% to about 5% by weight of the particles of a care enzyme. The particle can comprise from about 0.5% to less than 3% by weight of the particles of the care enzyme.

The particles can comprise about 40% to about 99% by weight of the particles a carrier and about 0.0001% to about 5% by weight of said particles of an enzyme. The particle can comprise from about 0.5% to less than 3% by weight of the particles of an enzyme.

The particles can comprise about 40% to about 99% by weight of the particles a carrier and about 0.0001% to about 5% by weight of said particles of an enzyme selected from the group consisting of care enzyme, nuclease, and combinations thereof. The particle can comprise from about 0.5% to less than 3% by weight of the particles of an enzyme selected from the group consisting of care enzyme, nuclease, and combinations thereof. The particle can comprise from about 0.5% to less than 3% by weight of the particles of an enzyme selected from the group consisting amylase, lipase, protease, cellulase, xyloglucanase, pectate lyase, peroxidases, mannanase, cutinases, P-nitrobenzylesterases, nucleases, and mixtures thereof.

For particle sizes having an individual mass described herein, this weight fraction of enzyme can provide for an effective amount of enzyme to rejuvenate the color of multiple articles of clothing when the plurality of particles collectively forming a dose for dosing to a laundry washing machine or wash basis is between about 1 g to about 27 g.

The nuclease enzyme is an enzyme capable of cleaving the phosphodiester bonds between the nucleotide sub-units of nucleic acids. The nuclease enzyme herein can be a deoxyribonuclease or ribonuclease enzyme or a functional fragment thereof. By functional fragment or part is meant the portion of the nuclease enzyme that catalyzes the cleavage of phosphodiester linkages in the DNA backbone and so is a region of said nuclease protein that retains catalytic activity. Thus it includes truncated, but functional versions, of the enzyme and/or variants and/or derivatives and/or homologues whose functionality is maintained.

The nuclease enzyme can be a deoxyribonuclease. The nuclease enzyme can be a deoxyribonuclease selected from the group consisting of any of the classes E.C. 3.1.21.x, where x=1, 2, 3, 4, 5, 6, 7, 8 or 9, E.C. 3.1.22.y where y=1, 2, 4 or 5, E.C. 3.1.30.z where z=1 or 2, E.C. 3.1.31.1 and mixtures thereof.

Nucleases in class E.C. 3.1.21.x cleave at the 3′ hydroxyl to liberate 5′ phosphomonoesters as follows:

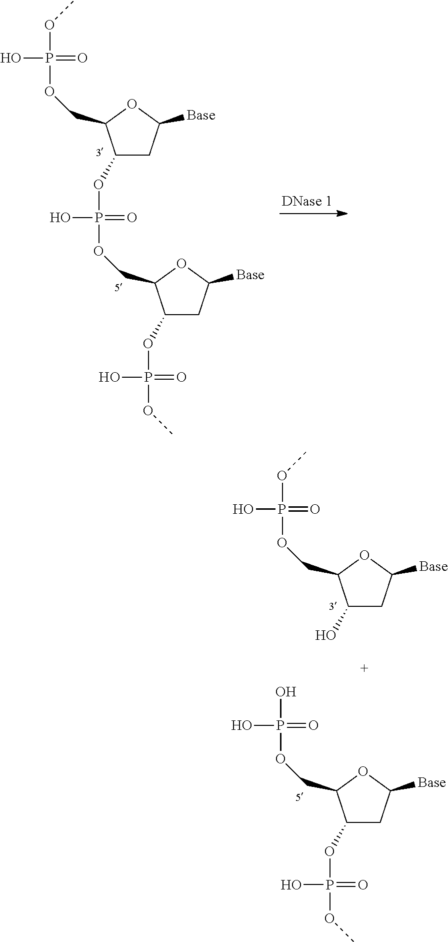

Nuclease enzymes from class E.C. 3.1.21.x and E.C. 3.1.21.x where x=1 can be practical.

Nucleases in class E.C. 3.1.22.y cleave at the 5′ hydroxyl to liberate 3′ phosphomonoesters. Enzymes in class E.C. 3.1.30.z can be practical as they act on both DNA and RNA and liberate 5′-phosphomonoesters. Suitable examples from class E.C. 3.1.31.2 are described in US2012/0135498A, such as SEQ ID NO:3 therein. Such enzymes are commercially available as DENARASE® enzyme from c-LECTA.

Nuclease enzymes from class E.C. 3.1.31.1 produce 3′phosphomonoesters.

The nuclease enzyme can comprise a microbial enzyme. The nuclease enzyme may be fungal or bacterial in origin. Bacterial nucleases can be practical. Fungal nucleases may practical as well.

The microbial nuclease is obtainable from Bacillus, such as a Bacillus licheniformis or Bacillus subtilis bacterial nucleases. A practical nuclease is obtainable from Bacillus licheniformis, preferably from strain EI-34-6. A practical deoxyribonuclease is a variant of Bacillus licheniformis, from strain EI-34-6 nucB deoxyribonuclease defined in SEQ ID NO:1 herein, or variant thereof, for example having at least 70% or 75% or 80% or 85% or 90% or 95%, 96%, 97%, 98%, 99% or 100% identical thereto.

Other suitable nucleases include those defined in SEQ ID NO:2 herein, or variant thereof, for example having at least 70% or 75% or 80% or 85% or 90% or 95%, 96%, 97%, 98%, 99% or 100% identical thereto. Other suitable nucleases include those defined in SEQ ID NO:3 herein, or variant thereof, for example having at least 70% or 75% or 80% or 85% or 90% or 95%, 96%, 97%, 98%, 99% or 100% identical thereto.

A fungal nuclease is obtainable from Aspergillus, for example Aspergillus oryzae. A preferred nuclease is obtainable from Aspergillus oryzae defined in SEQ ID NO: 5 herein, or variant thereof, for example having at least 60% or 70% or 75% or 80% or 85% or 90% or 95%, 96%, 97%, 98%, 99% or 100% identical thereto.

Another suitable fungal nuclease is obtainable from Trichoderma, for example Trichoderma harzianum. A practical nuclease can be obtained from Trichoderma harzianum defined in SEQ ID NO: 6 herein, or variant thereof, for example having at least 60% or 70% or 75% or 80% or 85% or 90% or 95%, 96%, 97%, 98%, 99% or 100% identical thereto.

Other fungal nucleases include those encoded by the DNA sequences of Aspergillus oryzae RIB40, Aspergillus oryzae 3.042, Aspergillus flavus NRRL3357, Aspergillus parasiticus SU-1, Aspergillus nomius NRRL13137, Trichoderma reesei QM6a, Trichoderma virens Gv29-8, Oidiodendron maius Zn, Metarhizium guizhouense ARSEF 977, Metarhizium majus ARSEF 297, Metarhizium robertsii ARSEF 23, Metarhizium acridum CQMa 102, Metarhizium brunneum ARSEF 3297, Metarhizium anisopliae, Colletotrichum fioriniae PJ7, Colletotrichum sublineola, Trichoderma atroviride IMI 206040, Tolypocladium ophioglossoides CBS 100239, Beauveria bassiana ARSEF 2860, Colletotrichum higginsianum, Hirsutella minnesotensis 3608, Scedosporium apiospermum, Phaeomoniella chlamydospora, Fusarium verticillioides 7600, Fusarium oxysporum f. sp. cubense race 4, Colletotrichum graminicola M1.001, Fusarium oxysporum FOSC 3-a, Fusarium avenaceum, Fusarium langsethiae, Grosmannia clavigera kw1407, Claviceps purpurea 20.1, Verticillium longisporum, Fusarium oxysporum f. sp. cubense race 1, Magnaporthe oryzae 70-15, Beauveria bassiana D1-5, Fusarium pseudograminearum CS3096, Neonectria ditissima, Magnaporthiopsis poae ATCC 64411, Cordyceps militaris CM01, Marssonina brunnea f. sp. ‘multigermtubi’ MB_m1, Diaporthe ampelina, Metarhizium album ARSEF 1941, Colletotrichum gloeosporioides Nara gc5, Madurella mycetomatis, Metarhizium brunneum ARSEF 3297, Verticillium alfalfae VaMs. 102, Gaeumannomyces graminis var. tritici R3-111a-1, Nectria haematococca mpVI 77-13-4, Verticillium longisporum, Verticillium dahliae VdLs.17, Torrubiella hemipterigena, Verticillium longisporum, Verticillium dahliae VdLs.17, Botrytis cinerea B05.10, Chaetomium globosum CBS 148.51, Metarhizium anisopliae, Stemphylium lycopersici, Sclerotinia borealis F-4157, Metarhizium robertsii ARSEF 23, Myceliophthora thermophila ATCC 42464, Phaeosphaeria nodorum SN15, Phialophora attae, Ustilaginoidea virens, Diplodia seriata, Ophiostoma piceae UAMH 11346, Pseudogymnoascus pannorum VKM F-4515 (FW-2607), Bipolaris oryzae ATCC 44560, Metarhizium guizhouense ARSEF 977, Chaetomium thermophilum var. thermophilum DSM 1495, Pestalotiopsis fici W106-1, Bipolaris zeicola 26-R-13, Setosphaeria turcica Et28A, Arthroderma otae CBS 113480 and Pyrenophora tritici-repentis Pt-1C-BFP.

The nuclease can be an isolated nuclease.

The nuclease enzyme can be present in a the laundering aqueous solution in an amount of from about 0.01 ppm to about 1000 ppm of the nuclease enzyme, or from about 0.05 or from about 0.1 ppm to about 750 or about 500 ppm.

The nucleases may also give rise to biofilm-disrupting effects.

The composition can additionally comprises a β-N-acetylglucosaminidase enzyme from E.C. 3.2.1.52, preferably an enzyme having at least 70%, or at least 75% or at least 80% or at least 85% or at least 90% or at least 95% or at least 96% or at least 97% or at least 98% or at least 99% or at least or 100% identity to SEQ ID NO:4.

### Dye

The particles may comprise dye. The dye may include those dyes that are typically used in laundry detergent or fabric softeners. The fabric treatment composition may comprise less than about 0.1%, alternatively about 0.001% to about 0.1%, alternatively about 0.01% to about 0.02%, alternatively combinations thereof and any hundredths of percent or ranges of hundredths of percent within any of the aforementioned ranges, of dye by weight of the particles of fabric treatment composition. Examples of suitable dyes include, but are not limited to, LIQUITINT PINK AM, AQUA AS CYAN 15, and VIOLET FL, available from Milliken Chemical. Employing a dye can be practical to help the user differentiate between particles having differing scents.

### Perfume

In addition to the carrier, the particles can further comprise 0.1% to about 20% by weight perfume. The perfume can be unencapsulated perfume, encapsulated perfume, perfume provided by a perfume delivery technology, or a perfume provided in some other manner. Perfumes are generally described in U.S. Pat. No. 7,186,680 at column 10, line 56, to column 25, line 22. The particles can comprise unencapsulated perfume and are essentially free of perfume carriers, such as a perfume microcapsules. The particles can comprise perfume carrier materials (and perfume contained therein). Examples of perfume carrier materials are described in U.S. Pat. No. 7,186,680, column 25, line 23, to column 31, line 7. Specific examples of perfume carrier materials may include cyclodextrin and zeolites.

The particles can comprise about 0.1% to about 20%, alternatively about 1% to about 15%, alternatively 2% to about 10%, alternatively combinations thereof and any whole percentages within any of the aforementioned ranges, of perfume by weight of the particles. The particles can comprise from about 0.1% by weight to about 6% by weight of the particles of perfume. The perfume can be unencapsulated perfume and or encapsulated perfume.

The particles can be free or substantially free of a perfume carrier. The particles may comprise about 0.1% to about 20%, alternatively about 1% to about 15%, alternatively 2% to about 10%, alternatively combinations thereof and any whole percentages within any of the aforementioned ranges, of unencapsulated perfume by weight of the particles.

The particles can comprise unencapsulated perfume and perfume microcapsules. The particles may comprise about 0.1% to about 20%, alternatively about 1% to about 15%, alternatively from about 2% to about 10%, alternatively combinations thereof and any whole percentages or ranges of whole percentages within any of the aforementioned ranges, of the unencapsulated perfume by weight of the particles. Such levels of unencapsulated perfume can be appropriate for any of the particles disclosed herein that have unencapsulated perfume.

The particles can comprise unencapsulated perfume and a perfume microcapsule but be free or essentially free of other perfume carriers. The particles can comprise unencapsulated perfume and perfume microcapsules and be free of other perfume carriers.

The particles can comprise encapsulated perfume. Encapsulated perfume can be provided as plurality of perfume microcapsules. A perfume microcapsule is perfume oil enclosed within a shell. The shell can have an average shell thickness less than the maximum dimension of the perfume core. The perfume microcapsules can be friable perfume microcapsules. The perfume microcapsules can be moisture activated perfume microcapsules.

The perfume microcapsules can comprise a melamine/formaldehyde shell. Perfume microcapsules may be obtained from Appleton, Quest International, or International Flavor & Fragrances, or other suitable source. The perfume microcapsule shell can be coated with polymer to enhance the ability of the perfume microcapsule to adhere to fabric. This can be desirable if the particles are designed to be a fabric treatment composition. The perfume microcapsules can be those described in U.S. Patent Pub. 2008/0305982.

The particles can comprise about 0.1% to about 20%, alternatively about 0.1% to about 10%, alternatively about 1% to about 15%, alternatively 2% to about 10%, alternatively combinations thereof and any whole percentages within any of the aforementioned ranges, of encapsulated perfume by weight of the particles.

The particles can comprise perfume microcapsules but be free of or essentially free of unencapsulated perfume. The particles may comprise about 0.1% to about 20%, alternatively about 1% to about 15%, alternatively about 2% to about 10%, alternatively combinations thereof and any whole percentages within any of the aforementioned ranges, of encapsulated perfume by weight of the particles.

### Method of Making Particles

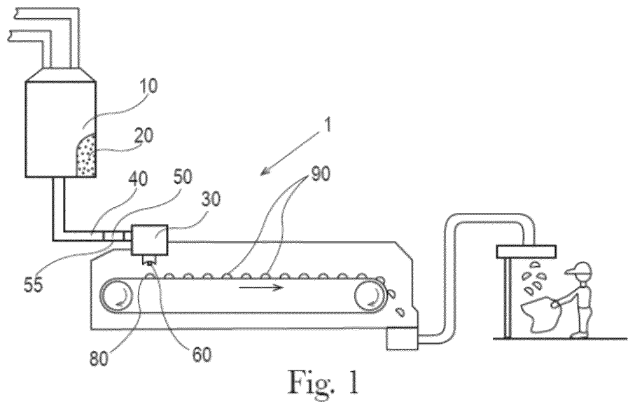

An apparatus 1 for forming particles is shown in FIG. 1. The raw material or raw materials are provided to a mixer 10. The mixer 10 has sufficient capacity to retain the volume of raw materials provided thereto for a sufficient residence time to permit the desired level of mixing and or reaction of the raw materials. The material leaving the mixer 10 is the precursor material 20. The precursor material 20 can be a molten product. The mixer 10 can be a dynamic mixer. A dynamic mixer is a mixer to which energy is applied to mix the contents in the mixer. The mixer 10 can comprise one or more impellers to mix the contents in the mixer 10.

Between the mixer 10 and the distributor 30, the precursor material 20 can be transported through the feed pipe 40. The feed pipe 40 can be in fluid communication with the mixer 10. An intermediate mixer 55 can be provided in fluid communication with the feed pipe 40 between the mixer 10 and the distributor 30. The intermediate mixer 55 can be a static mixer 50 in fluid communication with the feed pipe 40 between the mixer 10 and the distributor 30. The intermediate mixer 55, which can be a static mixer 50, can be downstream of the mixer 10. Stated otherwise, the mixer 10 can be upstream of the intermediate mixer 55 or static mixer 55 if employed. The intermediate mixer 55 can be a static mixer 50. The intermediate mixer 55 can be a rotor-stator mixer. The intermediate mixer 55 can be a colloid mill. The intermediate mixer 55 can be a driven in-line fluid disperser. The intermediate mixer 55 can be an Ultra Turrax disperser, Dispax-reactor disperser, Colloid Mil MK, or Cone Mill MKO, available from IKA, Wilmington, North Carolina, United States of America. The intermediate mixer 55 can be a perforated disc mill, toothed colloid mill, or DIL Inline Homogenizer, available from FrymaKoruma, Rheinfelden, Switzerland.

The distributor 30 can be provided with a plurality of apertures 60. The precursor material 20 can be passed through the apertures 60. After passing through the apertures 60, the precursor material 20 can be deposited on a moving conveyor 80 that is provided beneath the distributor 30. The conveyor 80 can be moveable in translation relative to the distributor 30.

The precursor material 20 can be cooled on the moving conveyor 80 to form a plurality of solid particles 90. The cooling can be provided by ambient cooling. Optionally the cooling can be provided by spraying the under-side of the conveyor 80 with ambient temperature water or chilled water.

Once the particles 90 are sufficiently coherent, the particles 90 can be transferred from the conveyor 80 to processing equipment downstream of the conveyor 80 for further processing and or packaging.

Particles comprising a carrier that is a water soluble polymer can be made, by way of non-limiting example, by forming particles from a melt of the composition that ultimately forms the particles. The rotoforming process can be practical to make particles comprising polyethylene glycol as the carrier material. Other process for forming particles can be suitable as well.

The process for forming particles can comprise the step of providing a precursor material. The precursor material can be a melt of the composition that ultimately forms the particles. The precursor material can be passed through apertures in a distributor that is provided. The distributor can have a plurality of apertures. A moving conveyor can be provided beneath the distributor. The precursor material can be deposited on the moving conveyor. The deposited precursor material can be cooled to form the plurality of particles. The cooling can be ambient cooling or cooling in which heat is removed from the deposited precursor material to form the plurality of particles.

To help preserve the activity of the enzyme, it can be desirable to provide the precursor material at as low a temperature as possible that permits suitable particles to be formed. The precursor material can be provided at a temperature less than about 70° C. The precursor material can be provided at a temperature between the melt point of the precursor material and about 70° C.

Rotoforming can be a practical process for forming particles from a melt. One suitable rotoforming device is a Sandvik ROTOFORM 3000 having a 750 mm wide 10 m long belt. The distributor of a rotoforming device is a rotating cylinder. The cylinder can have 2 mm diameter apertures set at a 10 mm pitch in the cross machine direction and 9.35 mm pitch in the machine direction. The cylinder can be set at approximately 3 mm above the belt. The belt speed and rotational speed of the cylinder can be set at about 10 m/min.

The precursor material can be provided from a mixer. The precursor material can be pumped from the mixer through a plate and frame heat exchanger set to control the outlet temperature.

The precursor material can be prepared in a batch or continuous mixer. Molten carrier material can be provided and the other constituents of the particle can be mixed with the molten carrier.

Particles can also be made using other approaches. For instance, granulation or press agglomeration can be appropriate. In granulation, the precursor material is compacted and homogenized by rotating mixing tools and granulated to form particles. For precursor materials that are substantially free of water, a wide variety of sizes of particles can be made.

In press agglomeration, the precursor material is compacted and plasticized under pressure and under the effect of shear forces, homogenized and then discharged from the press agglomeration machine via a forming/shaping process. Press agglomeration techniques include extrusion, roller compacting, pelleting, and tableting.

The precursor material can be delivered to a planetary roll extruder or twin screw extruder having co-rotating or contra-rotating screws. The barrel and the extrusion granulation head can be heated to the desired extrusion temperature. The precursor material can be compacted under pressure, plasticized, extruded in the form of strands through a multiple-bore extrusion die in the extruder head, and sized using a cutting blade. The bore diameter of the of extrusion header can be selected to provide for appropriately sized particles. The extruded particles can be shaped using a spheronizer to provide for particles that have a spherical shape.

Optionally, the extrusion and compression steps may be carried out in a low-pressure extruder, such as a flat die pelleting press, for example as available from Amandus Kahl, Reinbek, Germany. Optionally, the extrusion and compression steps may be carried out in a low pressure extruder, such as a BEXTRUDER, available from Hosokawa Alpine Aktiengesellschaft, Augsburg, Germany.

The particles can be made using roller compacting. In roller compacting the precursor material is introduced between two rollers and rolled under pressure between the two rollers to form a sheet of compactate. The rollers provide a high linear pressure on the precursor material. The rollers can be heated or cooled as desired, depending on the processing characteristics of the precursor material. The sheet of compactate is broken up into small pieces by cutting. The small pieces can be further shaped, for example by using a spheronizer.

### Examples/Combinations

A. A composition comprising a plurality of particles, wherein said particles comprise:
   from about 40% to about 99% by weight of said particles of a carrier; and
   from about 0.0001% to about 5% by weight of an enzyme selected from the group consisting of care enzyme, nuclease, and combinations thereof; and
   wherein each of said particles has a mass between about 1 mg to about 5000 mg.
B. The composition according to Paragraph A, wherein each of said particles has a mass between about 5 mg and about 200 mg.
C. The composition according to Paragraph A or B, wherein said carrier is a water soluble polymer.
D. The composition according to any one of Paragraphs A to C, wherein said particles comprise from more than 45% to about 99% by weight of said particles of said carrier.
E. The composition according to any one of Paragraphs A to D, wherein said carrier and said enzyme are substantially homogeneously mixed with one another.
F. The composition according to any one of Paragraphs A to E, wherein said enzyme is an enzyme particulate.
G. The composition according to any one of Paragraphs A to F, wherein said particles comprise from about 0.5% to less than 3% by weight of said particles of said enzyme.
H. The composition according to any one of Paragraphs A to G wherein said particles comprise from about 0.1% to about 20% by weight perfume.
I. The composition according to any one of Paragraphs A to H, wherein said carrier is polyethylene glycol, wherein said polyethylene glycol has a weight average molecular weight from about 2000 to about 13000.
J. The composition according to any one of Paragraphs A to I, wherein said particles comprise from about 0.1% to about 10% by weight encapsulated perfume.
K. The composition according to any one of Paragraphs A to J, wherein said enzyme is a care enzyme of the glycosyl hydrolase family 45.
L. The composition according to any one of Paragraphs A to K, wherein said plurality of particles is substantially free from particles having a mass less than about 10 mg.
M. The composition according to any one of Paragraphs A to L, wherein said carrier is selected from the group consisting of sucrose, sucrose bentonite, water soluble organic alkali metal salt, water soluble inorganic alkaline earth metal salt, water soluble organic alkaline earth metal salt, water soluble carbohydrate, water soluble silicate, water soluble urea, starch, clay, water insoluble silicate, citric acid carboxymethyl cellulose, fatty acid, fatty alcohol, glyceryl diester of hydrogenated tallow, glycerol, polyethylene glycol, and combinations thereof.
N. A process for treating laundry articles comprising the steps of:
   providing particles comprising:
   from about 40% to about 99% by weight of said particles of a carrier; and from about 0.0001% to about 5% by weight of an enzyme selected from the group consisting of care enzyme, nuclease, and combinations thereof;
   placing a dose of said particles in a dosing cup; and dispensing said dose of said particles into a washing machine;
   wherein each of said particles has a mass between about 1 mg to about 5000 mg.
O. The process according to Paragraph N, wherein said care enzyme is an enzyme of the glycosyl hydrolase family 45.
P. The process according to Paragraph N or O, wherein said carrier is polyethylene glycol, wherein said polyethylene glycol has a weight average molecular weight from about 2000 to about 13000.
Q. A process for forming particles comprising the steps of:
   providing a precursor material;
   providing a distributor having a plurality of apertures;
   passing said precursor material through said apertures;
   providing a moving conveyor beneath said distributor;
   depositing said precursor material onto said moving conveyor; and cooling said precursor material to form a plurality of particles;
   wherein said precursor material comprises polyethylene glycol, wherein said polyethylene glycol has a weight average molecular weight from about 2000 to about 13000;
   wherein said precursor material comprises from about 0.0001% to about 5% by weight of said precursor material of an enzyme selected from the group consisting of care enzyme, nuclease, and combinations thereof; and
   wherein said precursor material is provided at a temperature less than about 70° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1-20. (canceled)

21. A composition comprising a plurality of particles, wherein said particles comprise:
from about 45% to about 99% by weight water soluble polymer;
from about 0.1% to about 20% by weight perfume; and
an alkali metal salt selected from the group of alkali metal chlorides, alkali metal acetates, alkali metal citrates, and combinations thereof;
wherein individual said particles have a mass from about 5 mg to about 200 mg.

22. The composition according to claim 21, wherein said perfume is encapsulated perfume.

23. The composition according to claim 21, wherein said perfume is unencapsulated perfume.

24. The composition according to claim 21, wherein said perfume comprises encapsulated perfume and unencapsulated perfume.

25. The composition according to claim 21, wherein said water soluble polymer, said perfume, and said alkali metal salt are substantially homogeneously mixed with one another.

26. The composition according to claim 21, wherein said water soluble polymer is polyethylene glycol.

27. The composition according to claim 21, wherein said plurality of particles is substantially free from particles having a mass less than 10 mg.

28. The composition according to claim 21, wherein individual said particles have a shape selected from the group of spherical, hemispherical, compressed hemispherical, lentil shaped, and oblong.

29. The composition according to claim 21, wherein said plurality of particles comprises an enzyme substantially mixed with said water soluble polymer.

30. A composition comprising a plurality of particles, wherein said particles comprise:
from about 45% to about 99% by weight water soluble polymer;
from about 0.1% to about 20% by weight perfume; and
an alkali metal salt selected from the group of sodium chloride, sodium sulfate, sodium carbonate, sodium hydrogen carbonate, sodium acetate, sodium citrate, sodium silicate, potassium sulfate, potassium acetate, potassium citrate, magnesium, salts of calcium, alkaline metal chloride, alkaline metal sulfate, alkaline metal bisulfate, alkaline metal carbonate, alkaline metal monohydrogen carbonate, alkaline metal acetate, alkaline metal citrate, alkaline metal lactate, alkaline metal pyruvate, alkaline metal silicate, alkaline metal ascorbate, magnesium chloride, magnesium sulfate, magnesium carbonate, magnesium acetate, magnesium citrate, magnesium silicate, calcium chloride, calcium carbonate, calcium monohydrogen carbonate, calcium acetate, calcium citrate, and combinations thereof;
wherein individual said particles have a mass from about 5 mg to about 200 mg.

31. The composition according to claim 30, wherein said perfume is encapsulated perfume.

32. The composition according to claim 30, wherein said perfume is unencapsulated perfume.

33. The composition according to claim 30, wherein said water soluble polymer, said perfume, and said alkali metal salt are substantially homogeneously mixed with one another.

34. The composition according to claim 30, wherein said water soluble polymer is polyethylene glycol.

35. The composition according to claim 30, wherein said plurality of particles is substantially free from particles having a mass less than 10 mg.

36. A composition comprising a plurality of particles, wherein said particles comprise:
from about 45% to about 99% by weight water soluble polymer;
from about 0.1% to about 20% by weight perfume; and
a material selected from the group of sodium bicarbonate, sodium sulfate, sodium carbonate, sodium formate, calcium formate, sodium chloride, sucrose, maltodextrin, corn syrup solids, corn starch, wheat starch, rice starch, potato starch, tapioca starch, clay, silicate, citric acid carboxymethyl cellulose, fatty acid, fatty alcohol, glyceryl diester of hydrogenated tallow, glycerol, and combinations thereof;
wherein individual said particles have a mass from about 5 mg to about 200 mg.

37. The composition according to claim 36, wherein said perfume is encapsulated perfume.

38. The composition according to claim 36, wherein said perfume is unencapsulated perfume.

39. The composition according to claim 36, wherein said water soluble polymer, said perfume, and said alkali metal salt are substantially homogeneously mixed with one another.

40. The composition according to claim 36, wherein individual said particles have a shape selected from the group of spherical, hemispherical, compressed hemispherical, lentil shaped, and oblong.


SEQUENCE LISTING (6 sequences)

SEQ ID NO: 1 - protein, 109 aa, Bacillus licheniformis
ARYDDVLYFPASRYPETGAHISDAIKAGHADVCTIERSGADKRRQESLKGIPTKPGFDRDEWPMAMCEEGGKGASVRYVSSSDNRGAGSWVGNRLNGYADGTRILFIVQ

SEQ ID NO: 2 - protein, 109 aa, Bacillus subtilis
ASSYDKVLYFPLSRYPETGSHIRDAIAEGHPDICTIDDGADKRREESLKGIPTKPGYDRDEWPMAVCEEGGAGADVRYVTPSDNRGAGSWVGNQMSSYPDGTRVLFIVQ

SEQ ID NO: 3 - protein, 109 aa, Bacillus licheniformis
ARYDDILYFPASRYPETGAHISDAIKAGHSDVCTIERSGADKRRQESLKGIPTKPGFDRDEWPMAMCEEGGKGASVRYVSSSDNRGAGSWVGNRLSGFADGTRILFIVQ

SEQ ID NO: 4 - protein, 361 aa, Aggregatibacter actinomycetemcomitans
NCCVKGNSIYPQKTSTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGVKYLQGLKSRQVDDEIDITNADSITFMQSLMSEVIDIFGDTSQHFHIGGDEFGYSVESNHEFITYANKLSYFLEKKGLKTRMWNDGLIKNTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKTNGDE

SEQ ID NO: 5 - protein, 204 aa, Aspergillus oryzae
KTGSGDSQSDPIKADLEVKGQSALPFDVDCWAILCKGAPNVLQRVNEKTKNSNRDRSGANKGPFKDPQKWGIKALPPKNPSWSAQDFKSPEEYAFASSLQGGTNAILAPVNLASQNSQGGVLNGFYSANKVAQFDPSKPQQTKGTWFQITKFTGAAGPYCKALGSNDKSVCDKNKNIAGDWGFDPAKWAYQYDEKNNKFNYVGK

SEQ ID NO: 6 - protein, 188 aa, Trichoderma harzianum
APAPMPTPPGIPTESSARTQLAGLTVAVAGSGTGYSRDLFPTWDAISGNCNAREYVLKRDGEGVQVNNACESQSGTWISPYDNASFTNASSLDIDHMVPLKNAWISGASSWTTAQREALANDVSRPQLWAVSASANRSKGDRSPDQWKPPLTSFYCTYAKSWIDVKSFYKLTITSAEKTALSSMLDTC